(19) United States
(12) Patent Application Publication
(10) Pub. No.: US 2016/0205987 A1
(43) Pub. Date: Jul. 21, 2016

(54) TWO-STAGE STERILIZATION PROCESS FOR TREATING HEAT-RESISTANT SPORES IN GREAT BURDOCK EXTRACT DRINK

(71) Applicant: BURDOCK BIOTECH TAIWAN CO., LTD., Kaohsiung City (TW)

(72) Inventors: Zwe-Ling KONG, Kaohsiung City (TW); Te-Chun TSOU, Kaohsiung City (TW); Shih-Chiang LEE, Kaohsiung City (TW)

(73) Assignee: BURDOCK BIOTECH TAIWAN CO., LTD., Kaohsiung City (TW)

(21) Appl. No.: 14/696,880

(22) Filed: Apr. 27, 2015

(30) Foreign Application Priority Data
Jan. 15, 2015 (TW) 104101280

(51) Int. Cl. A23L 2/46

(52) U.S. Cl. CPC A23L 2/46; A23V 2002/00

(57) ABSTRACT

The present invention is to provide a two-stage sterilization process for treating heat-resistant spores in a great burdock extract drink, which comprises the steps of sealing dried great burdock and water in a double-kettle pressure cooker; heating liquid mixture of great burdock and water to a first temperature range lower than or equal to 100° C. for at least a first duration during a first-stage sterilization; opening lid of the cooker and filtering out great burdock residue so that all that remains in the cooker is great burdock extract; resealing the cooker and heating the great burdock extract to a second temperature range higher than or equal to 120° C. for at least a second duration during a second-stage sterilization, and the pressure in the cooker during the second-stage sterilization is higher than that during the first-stage sterilization; so as to obtain the extract drink free of common bacteria and heat-resistant spores.

### FIELD OF THE INVENTION

The present invention relates to a process for treating heat-resistant spores in a great burdock extract drink, more particularly to a two-stage sterilization process for treating heat-resistant spores in the great burdock extract drink, which begins by sealing dried great burdock and water in a double-kettle pressure cooker. Then, a first-stage sterilization is carried out, in which liquid mixture of great burdock and water is heated to a first temperature range for at least a first duration before heating is stopped. After that, a lid of the cooker is opened, and great burdock residue is filtered out so that all that remains in the double-kettle pressure cooker is great burdock extract. The double-kettle pressure cooker is then resealed for a second-stage sterilization, in which the great burdock extract is heated to a second temperature range higher than the first temperature range for at least a second duration before heating is stopped, and the pressure in the double-kettle pressure cooker during the second-stage sterilization is higher than that during the first-stage sterilization. Once the great burdock extract cools down to room temperature, a great burdock extract drink free of common bacteria and heat-resistant spores is obtained.

### BACKGROUND OF THE INVENTION

Great burdock (Arctium lappa L.), also known as greater burdock or edible burdock, is a biennial plant of the Arctium genus in the Asteraceae family. For centuries, it has been viewed by the Chinese as an important medicinal material in traditional Chinese medicine as well as a vegetable contributing to the maintenance of health. Great burdock is highly nutritious and is rich in inulin, various vitamins, protein, calcium, phosphorus, iron, and dietary fibers. For example, great burdock contains 150˜270 times as much carotene as carrot. Carotene can transform within the human body into vitamin A, which helps remove toxins from the human body, prevent tumors, cure nyctalopia (night blindness), and maintain good eyesight. The polyphenol constituents of great burdock consist essentially of chlorogenic acid, followed by caffeic acid, both of which acids can fight free radicals more effectively than vitamin E. As to protein and calcium content, great burdock is the highest of all root and stem vegetables. In addition, the large amount of dietary fibers in great burdock includes 50% of soluble fibers and 50% of insoluble fibers—a ratio conducive to enhanced activity of lactic acid bacteria and therefore beneficial to those who suffer from constipation. Dietary fibers are also referred to as the seventh nutrient and can increase the secretion of saliva, gastric fluid, intestinal fluid, and bile, thereby reducing the absorption of fat, delaying the absorption of sugars into the intestinal tract, promoting peristalsis, and facilitating the removal of harmful substances.

Great burdock has a unique sweetness, fragrance, and chewiness. The sweetness of great burdock comes from arginine, which is capable of stimulating the immune system, promoting the secretion of various important hormones, enhancing physical strength, and restoring vitality. Therefore, regular consumption of great burdock helps improve weak body constitution and can slow the aging process effectively. The distinctive flavor of great burdock is favored by many and is attributable to such chemical constituents as sulfur-containing acetylenic compounds, polyynes, polyphenols, volatile oils, and inulin. According to Compendium of Materia Medica, great burdock can “clear the twelve meridians and rid the five zang organs of bad qi” as well “lighten the body and defy aging if consumed persistently”. That is to say, great burdock has such medical properties as discharging toxins, resisting aging, and slimming. Not only that, plenty of researches have shown that, in terms of pharmacological activity, great burdock is antibacterial, mutation- and cancer-preventing, antioxidant, anti-fatigue, anti-dementia, immunomodulatory, and able to lower blood pressure, blood sugar, and blood lipids. In light of the above, great burdock is indeed an ideal natural health food.

Recently, as the percentage of the elderly population rises, and with the changes in our living environment, the morbidity rates of chronic diseases are increasing significantly. Now that western medicine has yet to eradicate many of the severe chronic diseases, scientists are turning to the Mother Nature for solutions, hoping that the bottleneck of western medicine can be removed by further study of the traditional herbs, both western and oriental. Meanwhile, the general public is also looking to follow a more natural diet, and a trend toward natural food has formed. Consequently, given the increasing emphasis people nowadays attach to the maintenance of health, great burdock has become an important natural healthy ingredient in the food industry, in cooking, and in traditional Chinese medicine due to its abundant nutrients and various medicinal values.

In the health drink market of today, great burdock extract is typically obtained by thermal extraction and is used to make health drinks for daily consumption. During the production of such and many other drinks, high-temperature sterilization is an essential process for killing harmful microorganisms in the drinks so as to ensure product quality and safety. As is well known in the art, most microorganisms will be killed when subjected to a temperature 15° C. higher than the most suitable temperature for growth, but this does not apply to bacteria which produce spores, like those of the Bacillus genus. Spores have high resistance to heat. Some heat-resistant spores can survive even after heating at 100° C. for more than 30 minutes. Such spores, if present in a drink, will remain after high-temperature sterilization. Generally speaking, the pH value of a drink has a huge impact on the heat resistance of the microorganisms in the drink. For example, an acidic drink with a pH value lower than 4.6 can be effectively sterilized at atmospheric pressure and a temperature below 100° C., whereas a non-acidic drink with a pH value higher than 4.6 must undergo high-pressure, high-temperature sterilization in order to kill all the heat-resistant spores. Currently, despite the huge amount of attention paid to the market of drinks containing the extract of the root and/or stem of a plant (e.g., great burdock), defective sterilization has, as always, resulted in potential decay due to the existence of heat-resistant spores, which impairs the safety of such drinks significantly; a thorough sterilization process, however, tends to damage the amino acids, polyphenols, and volatile substances in great burdock because of the sustained high temperature and high pressure in the sterilization process and consequently alters the unique flavor and sweetness of great burdock, reducing the taste of great burdock extract drinks to that of ginseng tea, melted grass jelly, or white gourd punch.

The issue to be addressed by the present invention, therefore, is to design a sterilization process which not only can kill all the common bacteria and heat-resistant spores in a great burdock extract drink while the drink is made, but also allows the drink to retain the exceptional original flavor of great burdock.

### BRIEF SUMMARY OF THE INVENTION

After painstaking research and experiment, the inventor of the present invention finally succeeded in developing a two-stage sterilization process for treating heat-resistant spores in a great burdock extract drink. The present invention not only can eliminate common bacteria and heat-resistant spores in a great burdock extract drink during drink production, but also can preserve the exceptional original flavor of great burdock, with a view to providing a health drink which is both inexpensive and good for the maintenance of health.

It is an objective of the present invention to provide a two-stage sterilization process for treating heat-resistant spores in a great burdock extract drink. The two-stage sterilization process begins by sealing dried great burdock and water in a double-kettle pressure cooker. Then, the first-stage sterilization is carried out, in which the liquid mixture of great burdock and water is heated to a first temperature range and is kept in that temperature range for at least a first duration before heating is stopped. The first temperature range is lower than or equal to 100° C. After that, the lid of the cooker is opened, and the great burdock residue is filtered out so that all that remains in the double-kettle pressure cooker is a great burdock extract. The double-kettle pressure cooker is then resealed for the second-stage sterilization, in which the great burdock extract is heated to a second temperature range and is kept in that temperature range for at least a second duration before heating is stopped. The second temperature range is higher than or equal to 120° C., and the pressure in the double-kettle pressure cooker during the second-stage sterilization is higher than that during the first-stage sterilization. Once the great burdock extract cools down to room temperature, a great burdock extract drink free of common bacteria and heat-resistant spores is obtained. Thanks to the two-stage sterilization process, which features different temperature ranges, the great burdock extract drink also retains the exceptional original flavor of great burdock.

Another objective of the present invention is to provide the foregoing two-stage sterilization process, wherein dried great burdock and water are added into the double-kettle pressure cooker in a ratio of 0.5%˜5%:95%˜99.5% by weight, before the lid of the double-kettle pressure cooker is shut to seal the double-kettle pressure cooker. The double-kettle pressure cooker is provided therein with a plurality of scraping and stirring blades which are rotatable in the double-kettle pressure cooker to scrape the bottom and the inner wall of the cooker and thereby prevent great burdock from getting burned as may otherwise occur if the great burdock sticks to the inner wall. The scraping and stirring blades also serve to stir the liquid mixture of great burdock and water evenly.

Still another objective of the present invention is to provide the foregoing two-stage sterilization process, wherein during the first-stage sterilization, the pressure in the double-kettle pressure cooker is 0.6˜1.1 kg/cm², and the liquid mixture is heated to 90˜100° C. (i.e., the first temperature range) and is kept in that temperature range for more than 20 minutes (i.e., the first duration) before heating is stopped. The relatively low temperature range in the double-kettle pressure cooker is intended to kill common bacteria in the liquid mixture while the relatively low pressure in the double-kettle pressure cooker allows water to extract such beneficial constituents of great burdock as amino acids, polyphenols, and volatile substances with ease. Then, the lid of the cooker is opened, and the great burdock residue is filtered out such that only a great burdock extract is left in the double-kettle pressure cooker. After that, the double-kettle pressure cooker is sealed again in order to perform the second-stage sterilization on the great burdock extract in the double-kettle pressure cooker. During the second-stage sterilization, the pressure in the double-kettle pressure cooker is 2.0˜4.0 kg/cm², and the great burdock extract is heated to 120˜140° C. (i.e., the second temperature range) and kept in that temperature range for 20˜30 minutes (i.e., the second duration) before heating is stopped, in order for the relatively high temperature and pressure in the double-kettle pressure cooker to kill heat-resistant spores in the great burdock extract. Once the great burdock extract cools down to room temperature, a great burdock extract drink free of common bacterial and heat-resistant spores is obtained. The great burdock extract drink also retains the exceptional original flavor of great burdock owing to the different temperature ranges of the two-stage sterilization process.

### BRIEF DESCRIPTION OF THE SEVERAL VIEWS OF THE DRAWINGS

The above and other objectives as well as the technical features and effects of the present invention will be best understood by referring to the following detailed description of some illustrative embodiments in conjunction with the accompanying drawings, in which:

FIG. 1 is a schematic structural diagram of a conventional double-kettle pressure cooker; and

FIG. 2 is the flowchart of the sterilization process of the present invention.

### DETAILED DESCRIPTION OF THE INVENTION

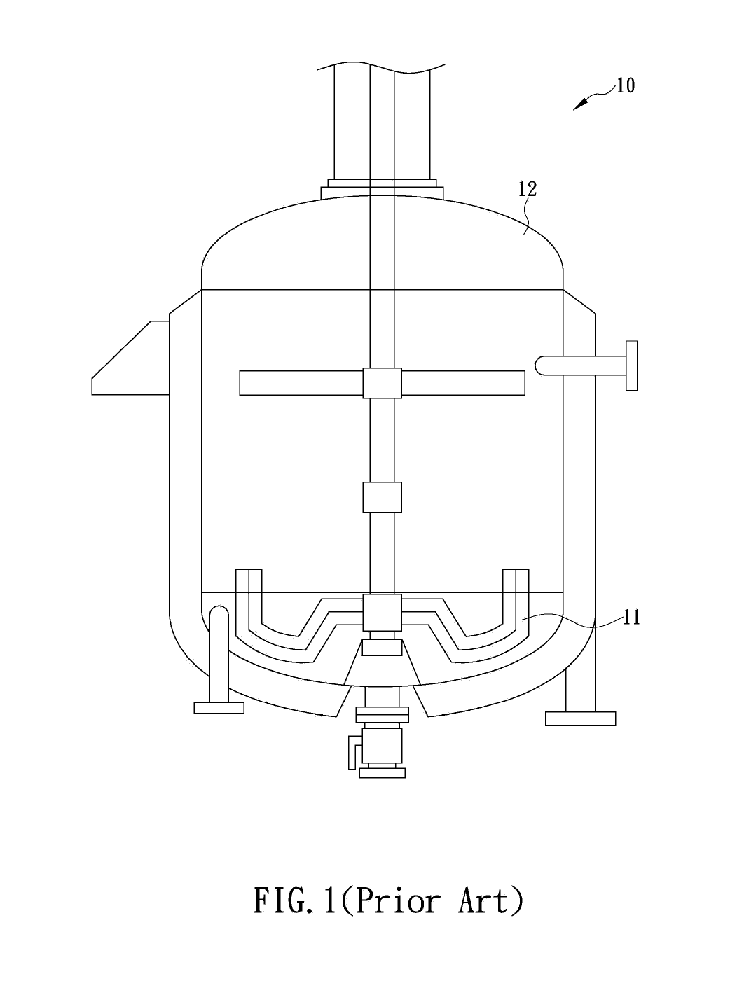

After conducting extensive research and experiment on the sterilization processes used in the production of commercial available drinks containing great burdock extract, the inventor of the present invention found that those sterilization processes are typically carried out in a double-kettle pressure cooker 10 as shown in FIG. 1. The double-kettle pressure cooker 10 is provided therein with a plurality of scraping and stirring blades 11 which can rotate in the double-kettle pressure cooker 10 so that a liquid mixture of great burdock and water in the cooker can be heated and stirred evenly. The scraping and stirring blades 11 can also scrape the bottom and the inner wall of the cooker to keep great burdock from sticking to the inner wall, thereby preventing the great burdock from getting burned, allowing the resulting great burdock extract drink to retain the original unique flavor of great burdock. However, once the liquid mixture is sterilized to produce a great burdock extract drink free of heat-resistant spores, the distinct flavor and sweetness of great burdock are changed.

In view of the above, the inventor tested and studied the various sterilization processes and conditions currently in use. A detailed description of how the inventor conducted two of the conventional sterilization processes is given below by way of example.

(1) Conventional sterilization process I: Referring to FIG. 1, dried great burdock and water were added into the double-kettle pressure cooker 10 in a ratio of 1%:99% by weight. The dried great burdock and the water weighed 100 kg in total. Then, the lid 12 of the double-kettle pressure cooker 10 was tightly closed to seal the double-kettle pressure cooker 10, and high-temperature, high-pressure sterilization was performed on the liquid mixture of great burdock and water. During the sterilization process, the pressure in the double-kettle pressure cooker 10 was 2.5˜3.5 kg/cm², and the liquid mixture was heated to 130° C. and was kept at 130° C. for more than 30 minutes before heating was stopped. The lid 12 was opened after the liquid mixture in the cooker cooled down to room temperature, and the great burdock residue was filtered out. Samples were then taken from the great burdock extract drink thus obtained and were assayed for total plate count, sugar content, and taste. The assay results are presented below:
(1-1) Total plate count: Not detected.
(1-2) Degrees Brix: 0.8.
(1-3) Taste evaluation by a panel of 10 people:

| | Degree of liking (score) | | | | |
|---|---|---|---|---|---|
| | Very low | Low | Fair | High | Very high |
| | (2) | (4) | (6) | (8) | (10) |
| Number of people | 1 | 3 | 5 | 1 | 0 |

Average score in taste evaluation: 5.2

(1-4) Remark: The samples of the great burdock extract drink lost the original unique flavor of great burdock and tasted like ginseng tea, melted grass jelly, or white gourd punch.

(2) Conventional sterilization process II: With continued reference to FIG. 1, dried great burdock and water were added into the double-kettle pressure cooker 10 in a ratio of 1%:99% by weight. The dried great burdock and the water weighed 100 kg in total. Then, the lid 12 of the double-kettle pressure cooker 10 was tightly closed to seal the double-kettle pressure cooker 10, and high-temperature, high-pressure sterilization was performed on the liquid mixture of great burdock and water. During the sterilization process, the pressure in the double-kettle pressure cooker 10 was 2.0˜2.5 kg/cm², and the liquid mixture was heated to 121° C. and was kept at 121° C. for more than 30 minutes before heating was stopped. The lid 12 was opened after the liquid mixture in the cooker cooled down to room temperature, and the great burdock residue was filtered out. Samples were then taken from the great burdock extract drink thus obtained and were assayed for total plate count, sugar content, and taste. The assay results are presented below:
(2-1) Total plate count: Not detected.
(2-2) Degrees Brix: 0.7.
(2-3) Taste evaluation by a panel of 10 people:

| | Degree of liking (score) | | | | |
|---|---|---|---|---|---|
| | Very low | Low | Fair | High | Very high |
| | (2) | (4) | (6) | (8) | (10) |
| Number of people | 1 | 4 | 4 | 1 | 0 |

Average score in taste evaluation: 5.0

(2-4) Remark: The samples of the great burdock extract drink also lost the original unique flavor of great burdock and tasted like ginseng tea, melted grass jelly, or white gourd punch.

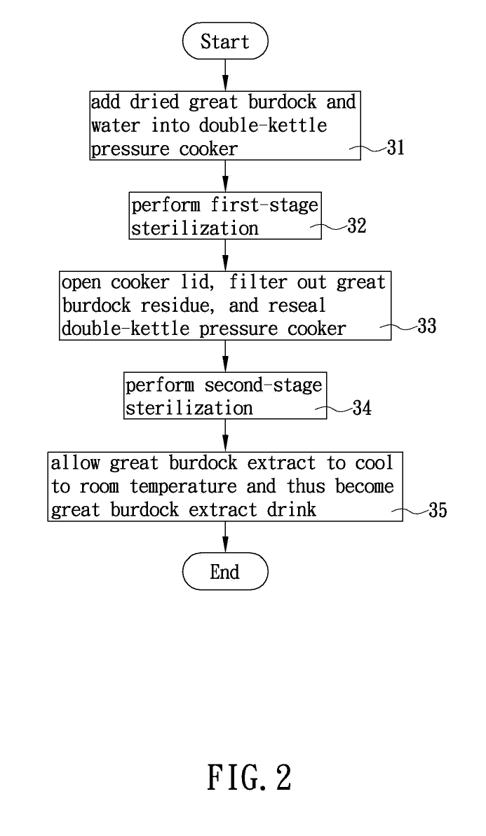

According to the inventor's further investigation, the main reasons why the samples of the aforesaid great burdock extract drinks lost the original unique flavor of great burdock are as follows. First, extraction and sterilization were carried out at the same time during the sterilization process. Second, the great burdock residue absorbed so much heat during the treatment of sustained high temperature and high pressure that certain constituents of great burdock (e.g., amino acids, polyphenols, and volatile substances) were destroyed, and because of that, the original unique flavor of great burdock was changed, giving rise to a taste similar to that of ginseng tea, melted grass jelly, or white gourd punch. After long-term research and experiment, the inventor finally succeeded in developing a two-stage sterilization process as disclosed herein. In the first-stage sterilization, a relatively low temperature is used to kill common bacteria in a liquid mixture of great burdock and water. Meanwhile, a relatively low pressure allows water to easily extract such beneficial constituents of great burdock as amino acids, polyphenols, and volatile substances. Then, great burdock residue is filtered out from the liquid mixture, and the second-stage sterilization is performed on the great burdock extract in the double-kettle pressure cooker in order to kill heat-resistant spores in the great burdock extract with a relatively high temperature and pressure. The two-stage sterilization process of the present invention is described below with reference to FIG. 1 and FIG. 2 based on an actual operation:

(31) To begin with, dried great burdock and water were added into the double-kettle pressure cooker 10 in a ratio of 0.5%˜5%:95%˜99.5%, wherein the total weight of great burdock and water was 100 kg. Then, the lid 12 of the double-kettle pressure cooker 10 was tightly closed to seal the double-kettle pressure cooker 10. As stated above, the double-kettle pressure cooker 10 is provided therein with plural scraping and stirring blades 11, which can rotate in the double-kettle pressure cooker 10 to scrape the bottom and the inner wall of the cooker, thereby preventing great burdock from sticking to the inner wall and getting burned. The scraping and stirring blades 11 also serve to stir the liquid mixture of great burdock and water evenly.

(32) The first-stage sterilization was performed on the liquid mixture in the double-kettle pressure cooker 10. More specifically, the pressure in the double-kettle pressure cooker 10 was 0.6˜1.1 kg/cm², and the liquid mixture was heated to 90˜100° C. (i.e., the first temperature range) and was kept in that temperature range for more than 20 minutes (i.e., the first duration) before heating was stopped. The relatively low temperature in the double-kettle pressure cooker 10 was used to kill common bacteria in the liquid mixture, and the relatively low pressure in the double-kettle pressure cooker 10 made it easy to extract the beneficial constituents of great burdock (e.g., amino acids, polyphenols, and volatile substances) with water.

(33) The lid 12 was opened, and the great burdock residue (i.e., the solid portions of the great burdock in the cooker) was filtered out, leaving only a great burdock extract in the double-kettle pressure cooker 10. Then, the double-kettle pressure cooker 10 was sealed again.

(34) The second-stage sterilization was performed on the great burdock extract in the double-kettle pressure cooker 10. More specifically, the pressure in the double-kettle pressure cooker 10 was 2.0˜4.0 kg/cm², and the great burdock extract was heated to 120˜140° C. (i.e., the second temperature range) and was kept in that temperature range for 20˜30 minutes (i.e., the second duration) before heating was stopped. The relatively high temperature and pressure in the double-kettle pressure cooker 10 were used to kill the remaining heat-resistant spores in the great burdock extract.

(35) Once the great burdock extract in the double-kettle pressure cooker 10 cooled down to room temperature, a great burdock extract drink was obtained. Samples were then taken from the drink and subjected to a total plate count test, a sugar content test, a pH test, and a taste evaluation. The test results are as follows:
(3-1) Total plate count: Not detected.
(3-2) Degrees Brix: 0.7 (with a dried great burdock to water ratio of 1%:99%).
(3-3) pH value: 5.66 (with a dried great burdock to water ratio of 1%:99%).
(3-4) Taste evaluation by a panel of 10 people (with a dried great burdock to water ratio of 1%:99%):

| | Degree of liking (score) | | | | |
|---|---|---|---|---|---|
| | Very low | Low | Fair | High | Very high |
| | (2) | (4) | (6) | (8) | (10) |
| Number of people | 0 | 1 | 5 | 3 | 1 |

Average score in taste evaluation: 7.9

(3-5) Remark: The samples of the great burdock extract drink retained the original unique flavor and sweetness of great burdock.

According to the above, the two-stage sterilization process of the present invention is so designed that, during the first-stage sterilization, the relatively low temperature (i.e., the first temperature range) in the double-kettle pressure cooker 10 can kill common bacteria in the liquid mixture of great burdock and water, and the relatively low pressure makes it easy to extract the beneficial constituents of great burdock with water. After the first-stage sterilization, the great burdock residue in the liquid mixture is immediately removed, and the second-stage sterilization featuring a relatively high temperature (i.e., the second temperature range) and relatively high pressure in the double-kettle pressure cooker 10 is performed on the great burdock extract to kill the heat-resistant spores remaining in the great burdock extract. Thus, the two-stage sterilization process of the present invention not only can eliminate common bacteria and heat-resistant spores in a great burdock extract drink during the production of the drink, but also can preserve the exceptional original flavor of great burdock at the same time. It is hoped that, by adopting the sterilization process of the present invention, great burdock extract drinks will become widely accepted and inexpensive health drinks that contribute to the maintenance of health of the general public.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A two-stage sterilization process for treating heat-resistant spores in a great burdock extract drink, comprising the steps of:
adding dried great burdock and water into a double-kettle pressure cooker in a ratio of 0.5%˜5%:95%˜99.5% by weight, and sealing the double-kettle pressure cooker by closing a lid of the double-kettle pressure cooker tightly, wherein the double-kettle pressure cooker is provided therein with a plurality of scraping and stirring blades rotatable in the double-kettle pressure cooker in order to scrape a bottom and an inner wall of the double-kettle pressure cooker, thereby preventing the great burdock from sticking to the inner wall and getting burned, and to stir a liquid mixture of the great burdock and the water evenly;
performing a first-stage sterilization on the liquid mixture in the double-kettle pressure cooker, wherein the liquid mixture is heated to a first temperature range and is kept in the first temperature range for at least a first duration before heating is stopped and, during the first-stage sterilization, the first temperature range is 90˜100° C. and the pressure in the double-kettle pressure cooker is 0.6˜1.1 kg/cm²;
opening the lid, filtering out solid portions of the great burdock such that only a great burdock extract is left in the double-kettle pressure cooker, and sealing the double-kettle pressure cooker again;
performing a second-stage sterilization on the great burdock extract in the double-kettle pressure cooker, wherein the great burdock extracted is heated to a second temperature range and is kept in the second temperature range for at least a second duration before heating is stopped and, during the second-stage sterilization, the second temperature range is 120˜140° C. and the pressure in the double-kettle pressure cooker is 2.0˜4.0 kg/cm²; and
allowing the great burdock extract in the double-kettle pressure cooker to cool to room temperature such that a great burdock extract drink free of common bacteria and heat-resistant spores and retaining an original flavor of the great burdock is obtained.

2-9. (canceled)

10. The two-stage sterilization process of claim 1, wherein the first duration is 20 minutes.

11. (canceled)

12. The two-stage sterilization process of claim 10, wherein the second duration is 20˜30 minutes.

13. The two-stage sterilization process of claim 1, wherein the first duration is sufficient to kill common bacteria in the liquid mixture.
